(19) United States
(12) Patent Application Publication
(10) Pub. No.: US 2011/0090918 A1
(43) Pub. Date: Apr. 21, 2011

(54) COMMUNICATION METHOD AND APPARATUS

(75) Inventors: Makoto Umehara, Kawasaki-shi (JP); Tomoyuki Takada, Tokyo (JP); Wataru Tachiwa, Yokohama-shi (JP); Hitoshi Asai, Tokyo (JP)

(73) Assignee: CANON KABUSHIKI KAISHA, Tokyo (JP)

(21) Appl. No.: 12/901,003

(22) Filed: Oct. 8, 2010

(30) Foreign Application Priority Data
Oct. 19, 2009 (JP) 2009-240875

(51) Int. Cl. H04J 3/00

(52) U.S. Cl. 370/442

(57) ABSTRACT

The parent station or a child station that transmits a pilot symbol is assigned to a pilot symbol transmission slot within a TDMA frame in a parent station or plurality of child stations for communicating using TDMA. The assigned parent station or child station transmits a pilot symbol using the pilot symbol transmission slot.

### BACKGROUND OF THE INVENTION

1. Field of the Invention

The present invention relates to a method of communication in a communication apparatus which functions as a parent station or child station that communicates using a TDMA (Time Division Multiple Access) scheme, and to the communication apparatus itself.

2. Description of the Related Art

A technique described in the specification of Japanese Patent Application Laid-Open No. 1-196924 is known as a method of performing synchronous detection of a distorted communication signal on a transmission line. As illustrated in FIG. 1 of the above-mentioned application, this method includes amplifying a data signal and equalizing phase using as a reference an already known pilot symbol inserted at regular intervals starting from the leading end of the data signal.

Further, the specification of Japanese Patent Application Laid-Open No. 2004-165830 discloses a technique in which the interval at which a pilot symbol is inserted is changed in accordance with transmission line variations, thereby eliminating redundant pilot symbols and improving transmission efficiency.

Such prior art is effective in a case where communication is performed with a remote station. However, the problem set forth below arises in a communication system in which a plurality of stations send and receive data at fixed periods using TDMA.

With a communication system for synchronously controlling a plurality of stations at a regular control period by feedback control, generally the TDMA frame length is set equal to the control period and all stations send and receive data every TDMA frame. For example, in a system for exercising feedback control of a mechanically driven part such as a motor, the control period is set to several milliseconds taking into consideration the characteristic of the operation time constant.

On the other hand, in a case where each station is connected on a wired transmission line, temporal variations on the transmission line are very small (several hundred milliseconds to more than tens of seconds). For this reason, there are many cases where variation time on a transmission line is longer than the TDMA frame length. In such cases it is preferred that the transmission interval of the pilot symbol of each station be set based upon the transmission line variation time.

With the above-described prior art, however, even if the technique described in Japanese Patent Application Laid-Open No. 2004-165830 is used, the fact that each station inserts a pilot symbol at the beginning of the data signal means that all stations transmit a pilot symbol at the TDMA frame period. Accordingly, redundant pilot symbols not essentially required are transmitted from each station.

More specifically, in a case where TDMA communication is performed in an environment in which the transmission line variation time is longer than the TDMA frame length, the transmission interval of the pilot symbol cannot be made greater than the length of the TDMA frame. The problem which arises is poor transmission efficiency.

Further, the greater the number of stations, the greater the number of pilot symbols that essentially do not participate in data transmission are transmitted. As a consequence, the data transmission band of the overall system declines. As a result, in a case where a fixed amount of data transmission band is required for every station in the above-mentioned feedback control system, the number of controllable stations is limited to a small value.

Naturally, it is possible to deal with this by raising the operation clock frequency of the communication unit to thereby increase the transmission band. In this case, however, other problems arise, namely an increase in power consumption and higher cost.

### SUMMARY OF THE INVENTION

The present invention provides an apparatus and method that make possible TDMA communication with high transmission efficiency achieved by eliminating redundant pilot symbols.

In accordance with one aspect of the present invention, there is provided a method of communication in a communication apparatus for functioning as a parent station or child station that communicates using TDMA, comprising: assigning the parent station or child station, which transmits a pilot symbol, to the pilot symbol transmission slot within a TDMA frame shared by the parent station and child station; and transmitting the pilot symbol in the pilot symbol transmission slot by the assigned parent station or child station.

In accordance with another aspect of the present invention, there is provided a communication apparatus for functioning as a parent station that communicates using TDMA, comprising: an assigning unit configured to assign the parent station or child station, which transmits a pilot symbol, to the pilot symbol transmission slot within a TDMA frame shared by the parent station and child station; and a transmitting unit configured to transmit the pilot symbol in the pilot symbol transmission slot by the assigned parent station.

Further features of the present invention will become apparent from the following description of exemplary embodiments with reference to the attached drawings.

### BRIEF DESCRIPTION OF THE DRAWINGS

FIG. 1 is a block diagram illustrating the internal functions of a parent station in a first embodiment of the present invention;

FIG. 2A is a diagram illustrating an example of the structure of a TDMA frame in the first embodiment, FIG. 2B is a diagram illustrating an example of the structure of a TDMA frame in a modification, and FIG. 2C is a diagram illustrating an example of the structure of a TDMA frame in a third embodiment of the present invention;

FIG. 3A is a diagram illustrating an example of time slot assignment in a time slot assigning unit in the first embodiment, and FIG. 3B is a diagram illustrating an example of time slot assignment in a time slot assigning unit in a second embodiment of the present invention;

FIG. 4 is a diagram illustrating content stored in a transmission line characteristic storage unit;

FIG. 5 is a block diagram illustrating the internal functions of a child station in the first embodiment;

FIG. 6 is a diagram illustrating the internal structure of a clock synchronizing unit shown in FIG. 5;

FIG. 7 is a block diagram illustrating the internal functions of a child station in the second embodiment;

FIG. 8 is a diagram illustrating an example of a data frame generated by a data frame generating unit in the second embodiment;

FIG. 9 is a block diagram illustrating the internal functions of a parent station in the second embodiment;

FIG. 10 is a flowchart illustrating the operation of a transmission line variation information extracting unit and time slot assigning unit of a parent station in the second embodiment;

FIG. 11 is a flowchart illustrating the operation of a transmission line variation information extracting unit and time slot generating unit of a child station in the second embodiment;

FIG. 12 is a flowchart illustrating the operation of a transmission line variation information extracting unit and time slot assigning unit of a parent station in the third embodiment;

FIG. 13 is a diagram illustrating an example of assignment of time slots in the third embodiment; and

FIG. 14 is a block diagram illustrating a connection environment according to the first to third embodiments of the present invention.

### DESCRIPTION OF THE EMBODIMENTS

Embodiments of the present invention will now be described in detail with reference to the drawings.

### First Embodiment

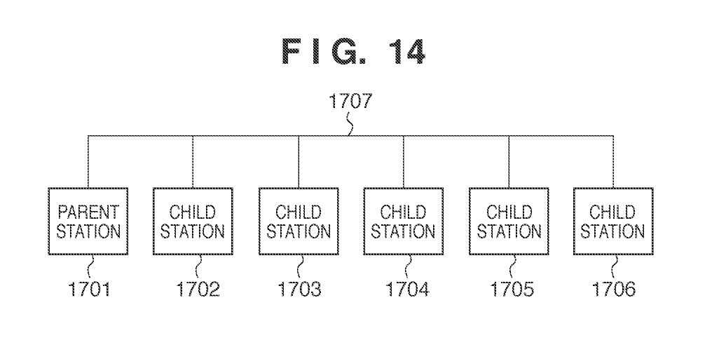

FIG. 14 is a block diagram illustrating a connection environment according to the first to third embodiments of the present invention. A parent station 1701 and a plurality of child stations 1702 to 1706 are connected by a transmission line 1707. Each station modulates transmission data by OFDM (Orthogonal Frequency Division Multiplexing) and communicates using TDMA. Although there are five child stations in this embodiment, the present invention is not limited to this number and is applicable to any number of such stations.

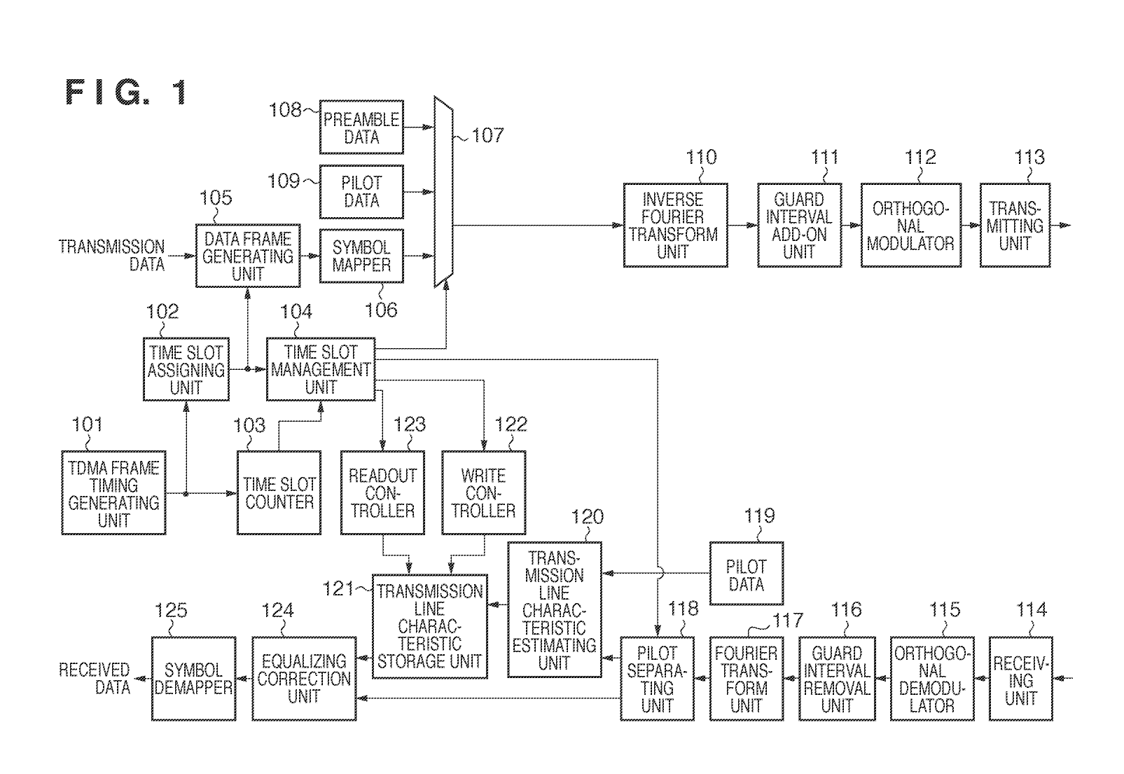

FIG. 1 is a block diagram illustrating the internal functions of a parent station in the first embodiment. A TDMA frame timing generating unit 101 shown in FIG. 1 notifies a time slot assigning unit 102 and a time slot counter 103 of the start timing of a TDMA frame. The time slot assigning unit 102 assigns a time slot within one TDMA frame to each station and outputs time slot assignment information to a time slot management unit 104 and data frame generating unit 105.

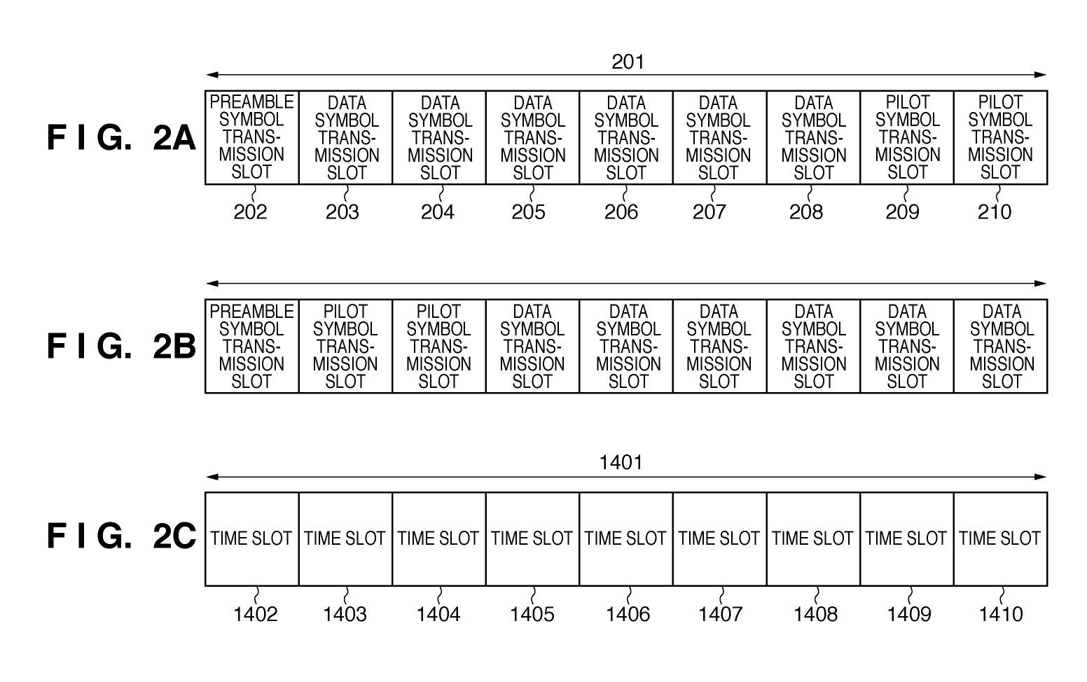

FIG. 2A illustrates an example of the structure of a TDMA frame in the first embodiment. The time slots within the TDMA frame are classified into L-number of slots for preamble symbol transmission, M-number of slots for data symbol transmission and N-number of slots for pilot symbol transmission. The length of time of each of the time slots is equal to the OFDM symbol length. In the embodiments below, a case where L=1, M=6, N=2 holds will be described as an example. However, the present invention is not limited to this arrangement and L, M, N may be decided freely.

A slot 202 for preamble symbol transmission is a slot in which the parent station 1701 transmits a preamble symbol. At the child stations 1702 to 1706, the boundary of the TDMA frame is detected by the preamble symbol transmitted from the parent station 1701. In addition, these are clock-synchronized to the parent station 1701. The time slot assigning unit 102 fixedly assigns the preamble symbol transmission slot 202 to the parent station 1701 and fixedly assigns data symbol transmission slots 203 to 208 to each of the stations. The time slot assigning unit 102 assigns pilot symbol transmission slots 209, 210 to each of the stations according to a predetermined pattern. That is, the time slot assigning unit 102 performs time slot assignment in such a manner that each station can make joint use of the pilot symbol transmission slots.

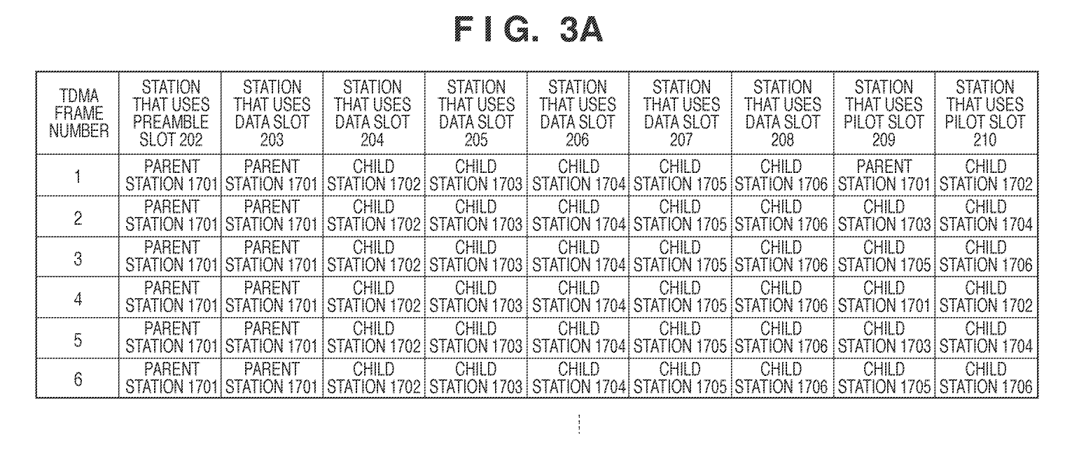

FIG. 3A is a diagram illustrating an example of time slot assignment by the time slot assigning unit in the first embodiment. The time slot assigning unit 102 assigns the pilot symbol transmission slots 209, 210 to each of the stations in such a manner that each station can transmit a pilot symbol every three TDMA frames. The time slot assigning unit 102 is constituted by a ROM, by way of example. In this case, by storing time slot assignment information equivalent to three TDMA frames in the ROM and changing the time slot assignment information read out every TDMA frame, it is possible to readily implement the time slot assigning unit 102.

Next, the time slot counter 103 is a counter reset whenever a TDMA frame starts and is incremented whenever the time of one time slot elapses. The time slot management unit 104 operates based upon the time slot assignment information and time slot count and outputs the present slot type and transmitting station to a changeover unit 107, write controller 122 and readout controller 123.

The data frame generating unit 105 generates a data frame comprising time slot assignment information and transmission data destined for the child stations 1702 to 1706 and outputs the data frame to a symbol mapper 106. For example, assume that amount of data capable of being transmitted by one OFDM symbol is 32 bytes and that the time slot assignment information is 2 bytes. In such case the data frame generating unit 105 outputs 2 bytes of time slot assignment information and 30 bytes of transmission data, which are destined for the child stations 1702 to 1706, to the symbol mapper 106. It should be noted that with regard to the transmission data, it may be so arranged that a header indicating the destination thereof is appended thereto.

The symbol mapper 106 maps the transmission data on a complex plane and outputs the data to the changeover unit 107. For example, the symbol mapper 106 maps the transmission data as by 64 QAM mapping. Based upon control by the time slot management unit 104, the changeover unit 107 outputs one item of data from among preamble data 108, pilot data 109 and mapped transmission data to an inverse Fourier transform unit 110. For example, in a case where the slot type is the pilot symbol transmission slot and the transmitting station is the local station, the changeover unit 107 outputs the pilot data 109 to the inverse Fourier transform unit 110. Here the preamble data 108 and pilot data 109 are known items of data predetermined among the parent station 1701 and child stations 1702 to 1706.

The inverse Fourier transform unit 110 subjects input data on the frequency axis to an inverse Fourier transform and converts the data to a valid symbol on the time axis. A guard interval add-on unit 111 appends a guard interval to the valid symbol to thereby generate an OFDM symbol and outputs the symbol to an orthogonal modulator 112. The orthogonal modulator 112 applies orthogonal modulation to the OFDM symbol, which is a complex signal, thereby generating an OFDM symbol, which is a real signal, and outputs this OFDM symbol to a transmitting unit 113. The transmitting unit 113 subjects the OFDM symbol to a D/A conversion and transmits the analog signal to the child stations 1702 to 1706.

These units operate to transmit the preamble symbol, pilot symbols and data symbols from the parent station 1701 in the time slots of FIG. 3A.

A receiving unit 114 receives the pilot symbols and data symbols transmitted from the child stations 1702 to 1706 and subjects these to an A/D conversion. The digital signal obtained from the conversion is subjected to orthogonal demodulation by an orthogonal demodulator 115 and the demodulated signal is output to a guard interval removal unit 116. The guard interval removal unit 116 removes the guard interval from the received signal and outputs the valid symbols to a Fourier transform unit 117. The Fourier transform unit 117 subjects the valid symbols to a Fourier transform and outputs the result to a pilot separating unit 118.

The pilot separating unit 118 operates based upon control by the time slot management unit 104. In a case where the type of slot is the pilot symbol transmission slot, the pilot separating unit 118 outputs the signal from the Fourier transform unit 117 to a transmission line characteristic estimating unit 120. In a case where the type of slot is the data symbol transmission slot, the pilot separating unit 118 delivers the signal from the Fourier transform unit 117 to an equalizing correction unit 124. That is, a received pilot symbol that has undergone the Fourier transform processing is output to the transmission line characteristic estimating unit 120, and a received data symbol that has undergone the Fourier transform processing is output to the equalizing correction unit 124.

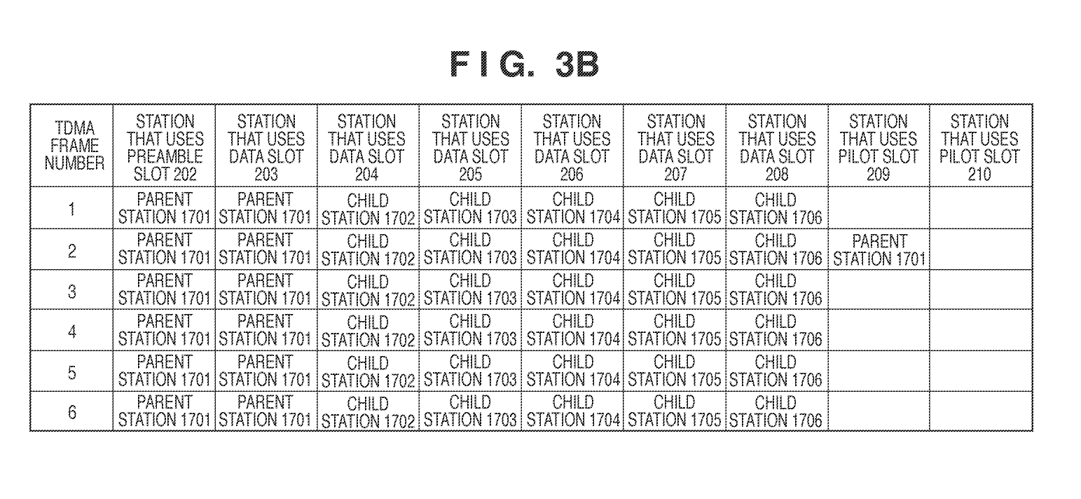

The transmission line characteristic estimating unit 120 subjects the output of the pilot separating unit 118 to complex division by pilot data 119 and estimates the transmission line characteristic. The pilot data 119 is known data identical with the pilot data 109 in the transmitting operation. Under the control of the write controller 122, the transmission line characteristic storage unit 121 stores the estimated transmission line characteristic data for every child station. Further, under the control of the readout controller 123, the transmission line characteristic storage unit 121 outputs the stored transmission line characteristic data to the equalizing correction unit 124. FIG. 4 is a diagram illustrating the content stored in the transmission line characteristic storage unit 121. Transmission line characteristic data for the transmission lines between the child stations 1702 to 1706 and parent station 1701 is stored in the transmission line characteristic storage unit 121.

The write controller 122 operates under the control of the time slot management unit 104 and, in a case where the type of slot is the pilot symbol transmission slot, exercises control in such a manner that transmission line characteristic data is written to the transmission line characteristic storage unit 121 per each transmitting station. For example, if pilot symbol transmission slot 210 of TDMA frame No. 1 is received, then the write controller 122 exercises control so as to write the transmission line characteristic data to address 0 of the transmission line characteristic storage unit 121.

The readout controller 123 operates under the control of the time slot management unit 104, and in a case where the type of slot is the data symbol transmission slot, exercises control in such a manner that transmission line characteristic data that conforms to the transmitting station is output from the transmission line characteristic storage unit 121. For example, if the data symbol transmission slot 204 transmitted by the child station 1702 is received, then the transmission line characteristic storage unit 121 is controlled so as to read out the transmission line characteristic data of address 0 from the transmission line characteristic storage unit 121.

The equalizing correction unit 124 subjects the output of the pilot separating unit 118 to complex division by the transmission line characteristic data that is output from the transmission line characteristic storage unit 121 and subjects the received signal to equalization correction processing. A symbol demapper 125 executes demapping such as 64 QAM and demodulates the received data.

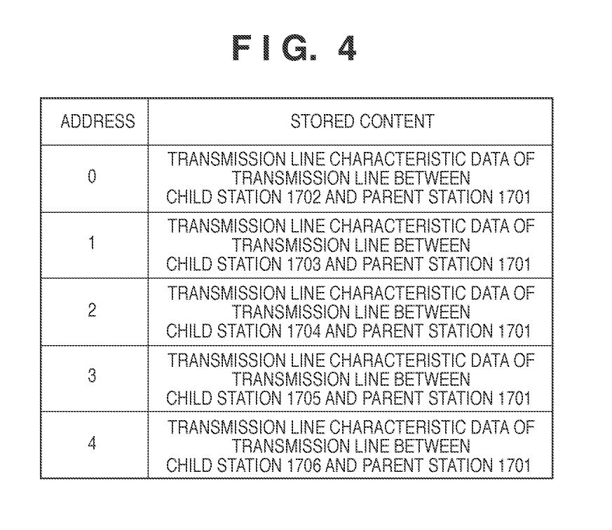

FIG. 5 is a block diagram illustrating the internal functions of a child station in the first embodiment. Functional blocks for performing operations identical with those of the parent station 1701 shown in FIG. 1 are designated by like reference characters and need not be described again in detail. An assignment information extracting unit 501 shown in FIG. 5 extracts time slot assignment information, which is transmitted by the parent station 1701, from the received data and outputs the time slot assignment information to the time slot management unit 104.

A preamble detecting unit 502 for detecting a preamble symbol from the output of the orthogonal demodulator 115 and outputs a TDMA-frame start timing pulse to the time slot counter 103 and to a clock synchronizing unit 503. In order to detect the preamble symbol, use is made of a mutual correlation operation which utilizes the fact that the preamble symbol is a known waveform. Further, it may be so arranged that the number L of preamble symbol transmission slots is two or more and the preamble symbol is detected by an autocorrelation operation.

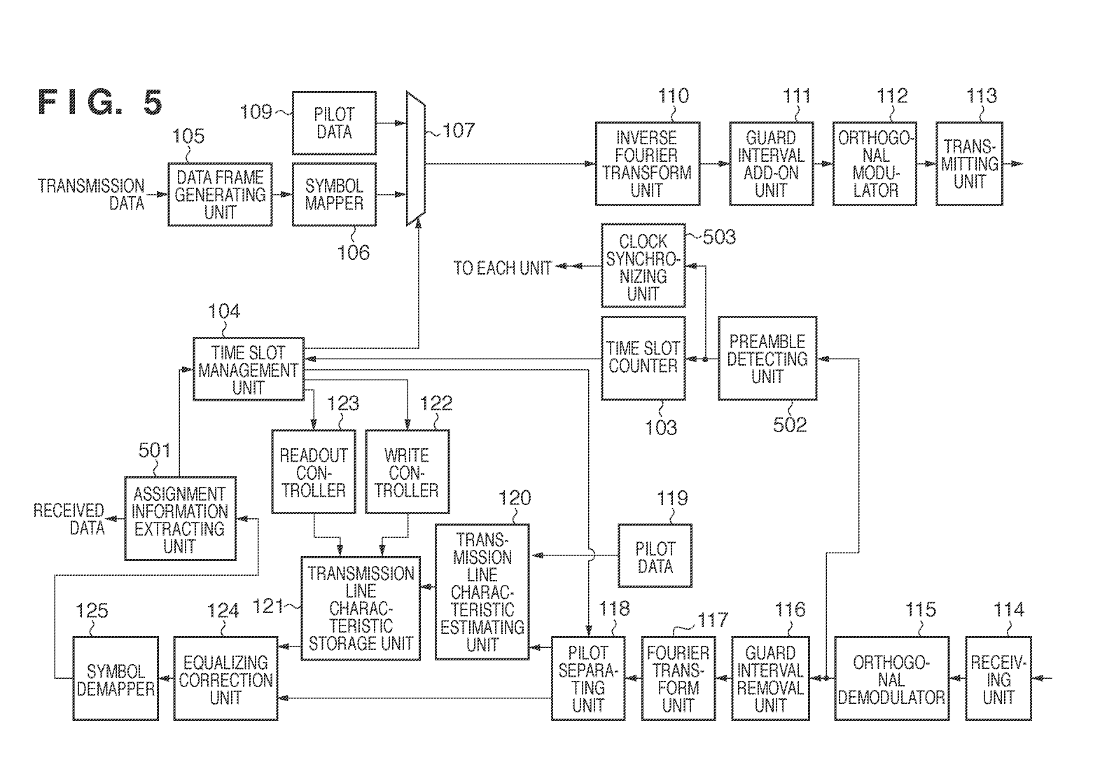

The clock synchronizing unit 503 outputs to each unit a clock signal synchronized to the parent station 1701. FIG. 6 is a diagram illustrating the internal structure of the clock synchronizing unit 503 shown in FIG. 5. The clock synchronizing unit 503 is constituted by reception interval counter 601, a count holding unit 602, an error voltage generator 603, an LPF (low-pass filter) 604 and a voltage-controlled oscillator 605.

The reception interval counter 601 is connected to the preamble detecting unit 502 and receives the TDMA-frame start timing pulse as an input. The reception interval counter 601 is a counter for counting up the TDMA frame intervals at the clock generated by the voltage-controlled oscillator 605. The count value is reset whenever there is an input of the timing pulse.

The count holding unit 602 holds the count value that is output by the reception interval counter 601 every TDMA-frame timing start pulse and outputs the count value to the error voltage generator 603. The error voltage generator 603 compares the count value, which is output by the count holding unit 602, with a prescribed value and outputs an error voltage conforming to the result of the comparison to the LPF 604.

The prescribed value is a value used when the TDMA-frame timing start pulse is counted at the clock signal synchronized to the parent station 1701. That is, if the count value is less than the prescribed value, this means that the frequency of the clock signal output by the voltage-controlled oscillator 605 is low in comparison with the clock frequency of the parent station 1701. On the other hand, if the count value is greater than the prescribed value, this means that the frequency of the clock signal output by the voltage-controlled oscillator 605 is high in comparison with the clock frequency of the parent station 1701.

Accordingly, if the count value is less than the prescribed value, the error voltage generator 603 generates an error voltage such that the frequency of the clock generated by the voltage-controlled oscillator 605 rises. If the count value is greater than the prescribed value, then the error voltage generator 603 generates an error voltage such that the frequency of the clock generated by the voltage-controlled oscillator 605 falls.

The LPF 604 eliminates high-frequency components of the error voltage generated by the error voltage generator 603 and outputs the resultant signal to the voltage-controlled oscillator 605. The voltage-controlled oscillator 605 is an oscillator in which the frequency of the output clock signal varies in accordance with the output of the LPF 604.

As a result of the operations performed by these components, a clock signal synchronized to the parent station 1701 can be generated in the clock synchronizing unit 503. It should be noted that the invention is not limited to the clock synchronizing method described above. For example, it may be so arranged that clock synchronization is achieved by sending and receiving a clock synchronizing signal in a prescribed frequency band.

Owing to the transmitting operation of the parent station 1701 and child stations 1702 to 1706, the preamble symbol, pilot symbols and data symbols are transmitted according to the time slot assignment shown in FIG. 3A. On the other hand, in the receiving operation, station-by-station transmission line characteristic data is stored and equalization processing using transmission line characteristic data conforming to the transmitting station is executed. As a result, communication in which the transmission interval of the pilot symbol of each station is made three TDMA frames becomes possible and TDMA communication featuring a high transmission efficiency can be implemented.

In the first embodiment, a case where the number N of pilot symbol transmission slots is two is described. However, this does not impose a limitation upon the present invention. For example, in an environment where there is only moderate variation on the transmission line, the pilot symbol transmission interval of each station can be made six TDMA frames by adopting N=1. This makes possible TDMA communication that is even more efficient.

In the first embodiment, the time slots within the TDMA frame are arranged in the following order: the preamble symbol transmission slot, the data symbol time slots and the pilot symbol transmission slots. However, the present invention is not limited to this arrangement. For example, as illustrated in FIG. 2B, the time slots may be arranged in the following order: the preamble symbol transmission slot, the pilot symbol transmission slots and the data symbol transmission slots.

In the first embodiment, as example is described in which the parent station 1701 assigns data symbol transmission slots to all stations. However, the present invention is not limited to this arrangement. For example, it may be so arranged that the parent station 1701 assigns data symbol transmission slots only to itself and the child stations 1702 to 1704. Further, in this case, it may be so arranged that the parent station 1701 assigns pilot symbol transmission slots only to itself and the child stations 1702 to 1704.

Thus, in the first embodiment, the parent station 1701 has the time slot assigning unit 102 for assigning pilot symbol transmission slots to each station according to a prescribed pattern. The parent station 1701 and child stations 1702 to 1706 have the transmission line characteristic storage unit 121 for storing transmission line characteristic data. They further include the write controller 122 for writing the transmission line characteristic data to the transmission line characteristic storage unit 121 per transmitting station, and the readout controller 123 for reading in the transmission line characteristic data from the transmission line characteristic storage unit 121 in accordance with the transmission source when a data symbol is received.

By virtue of the above-described arrangement, communication in which the transmission interval of the pilot symbol of each station is made longer than the TDMA frame length is possible. As a result, it is possible to perform TDMA communication with a high transmission efficiency achieved by eliminating redundant pilot symbols.

### Second Embodiment

A second embodiment according to the present invention will now be described in detail with reference to the drawings. In the second embodiment, the parent station 1701 and child stations 1702 to 1706 are provided with a transmission line variation detecting unit. The parent station 1701 assigns a pilot symbol transmission slot to a station in which transmission line variation has occurred. To facilitate the description, first the structure and operation of the child stations 1702 to 1706 in the second embodiment will be described.

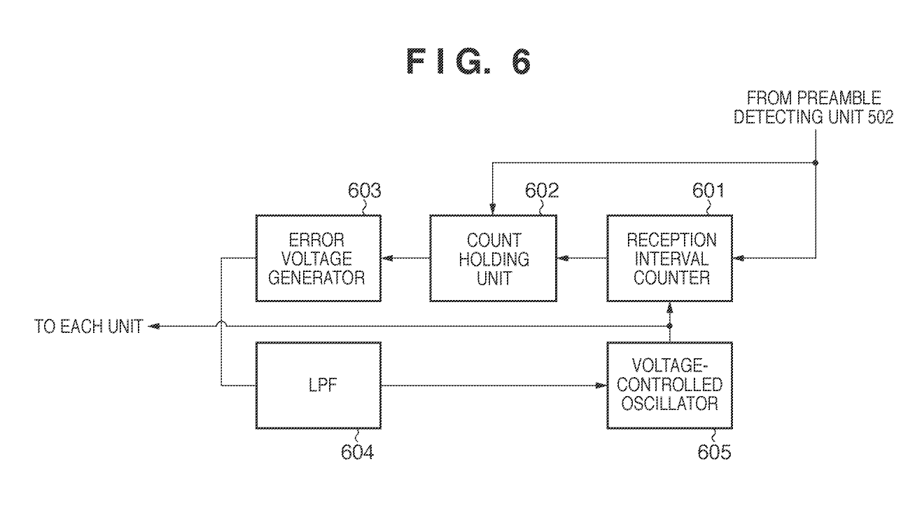

FIG. 7 is a block diagram illustrating the internal functions of a child station in the second embodiment. Here only internal functional blocks of the child stations 1702 to 1706 that differ from those in the first embodiment will be described. The other blocks are as described in the arrangement of the first embodiment.

An error-correcting encoder 801 subjects transmission data to error-correcting encoding processing. For example, a Reed-Solomon code or the like is used as the error-correcting code. An error-correcting decoder 802 detects whether an error has occurred in received data and corrects any correctable error. In a case where occurrence of an error has been detected, the error-correcting decoder 802 in the second embodiment gives notification of error occurrence to a transmission line variation information generating unit 803.

The transmission line variation information generating unit 803 generates transmission line variation information based upon the outputs from the time slot management unit 104 and error-correcting decoder 802. If the transmission line variation information generating unit 803 receives notification of error occurrence from the error-correcting decoder 802, it determines whether transmission line variation has occurred in the transmitting station of the relevant data symbol. The transmission line variation information generating unit 803 then generates transmission line variation information, which notifies the parent station 1701 of the station in which the transmission line variation occurred and of the number of error bits, and outputs this information to a data frame generating unit 804. On the other hand, if there is no notification of occurrence of error from the error-correcting decoder 802, then the transmission line variation information generating unit 803 outputs null data.

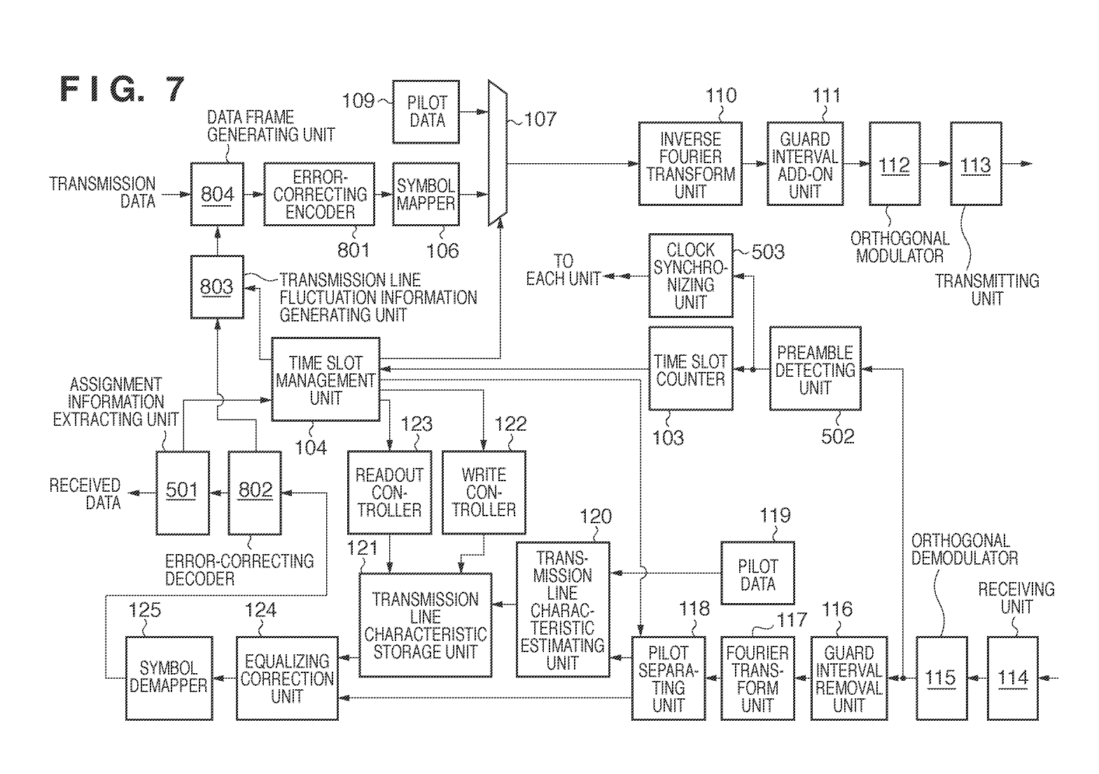

The data frame generating unit 804 generates a data frame comprising transmission data to another station and transmission line variation information transmitted to the parent station and outputs the data frame to the error-correcting encoder 801. FIG. 8 is a diagram illustrating an example of a data frame generated by the data frame generating unit in the second embodiment. By way of example, the data frame is constituted by a transmission line variation information insertion flag 901, transmission line variation information 902, a destination header 903 and transmission data 904.

The transmission line variation information insertion flag 901 is a 1-bit flag indicating whether the transmission line variation information 902 is valid or invalid. Transmission line variation information generated by the transmission line variation information generating unit 803 is inserted into the transmission line variation information 902. The destination header 903 is 1-byte data, by way of example, and describes the destination of the transmission data 904. In a case where the amount of data capable of being transmitted by one OFDM symbol is 32 bytes, the transmission data 904 is data composed of 32 bytes, one bit and one byte.

In a case where transmission line variation information has been input from the transmission line variation information generating unit 803, the data frame generating unit 804 generates a data frame in which the transmission line variation information insertion flag 901 has been enabled. On the other hand, in a case where null data has been input from the transmission line variation information generating unit 803, the data frame generating unit 804 generates a data frame in which the transmission line variation information insertion flag 901 has been disabled.

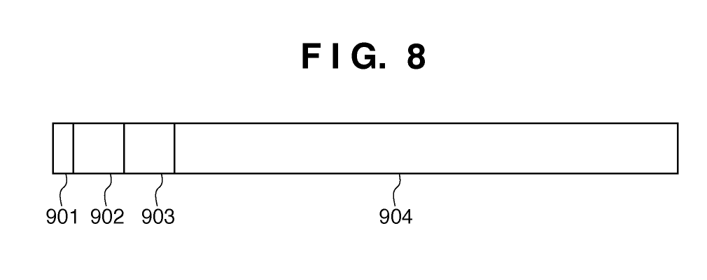

FIG. 9 is a block diagram illustrating the internal functions of a parent station in the second embodiment. It should be noted that only internal functional blocks of the parent station 1701 that differ from those in the first embodiment will be described. The other blocks are as described in the arrangement of the first embodiment.

Further, in FIG. 9, an error-correcting encoder 1001 and an error-correcting decoder 1002 operate in the same manner as the error-correcting encoder 801 and error-correcting decoder 802 in the child stations 1702 to 1706.

A transmission line variation information extracting unit 1003 identifies the transmission line variation information insertion flag within the received data and, in a case where the flag has been enabled, extracts the transmission line variation information and notifies a time slot assigning unit 1004 of a station in which transmission line variation has occurred. On the basis of the outputs from the error-correcting decoder 1002 and transmission line variation information extracting unit 1003, the time slot assigning unit 1004 assigns the pilot symbol transmission slot of the next TDMA frame to the station where the transmission line variation occurred.

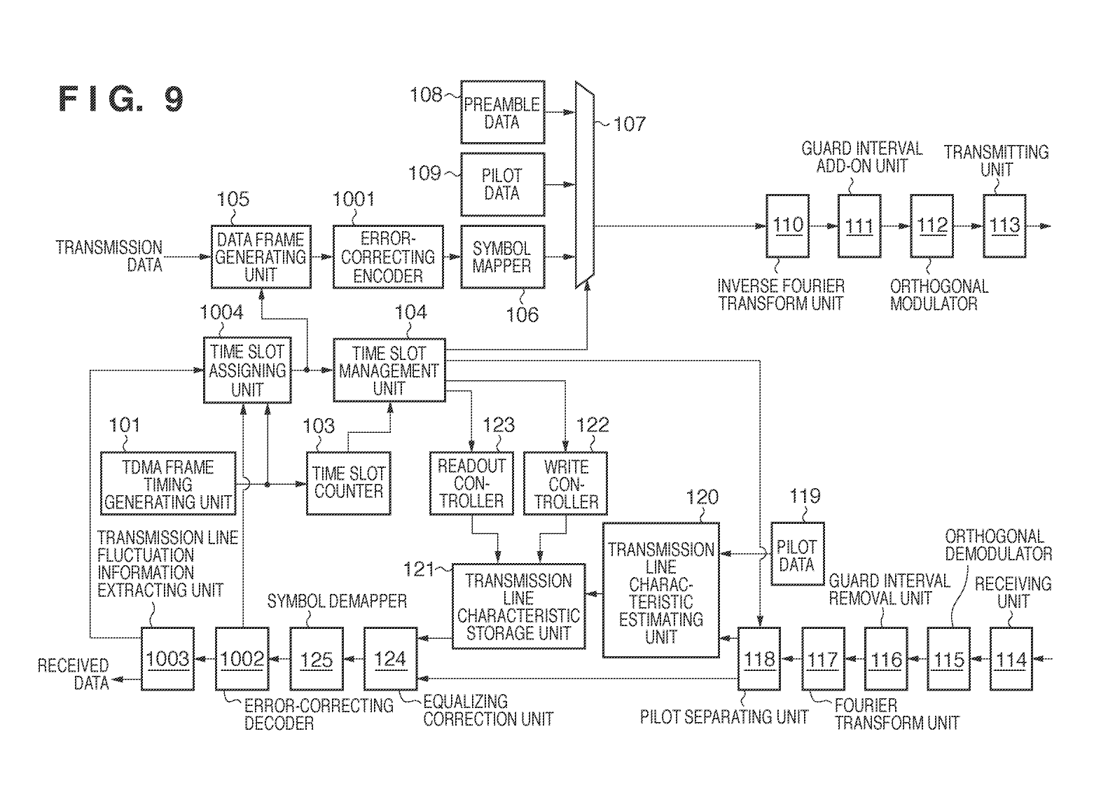

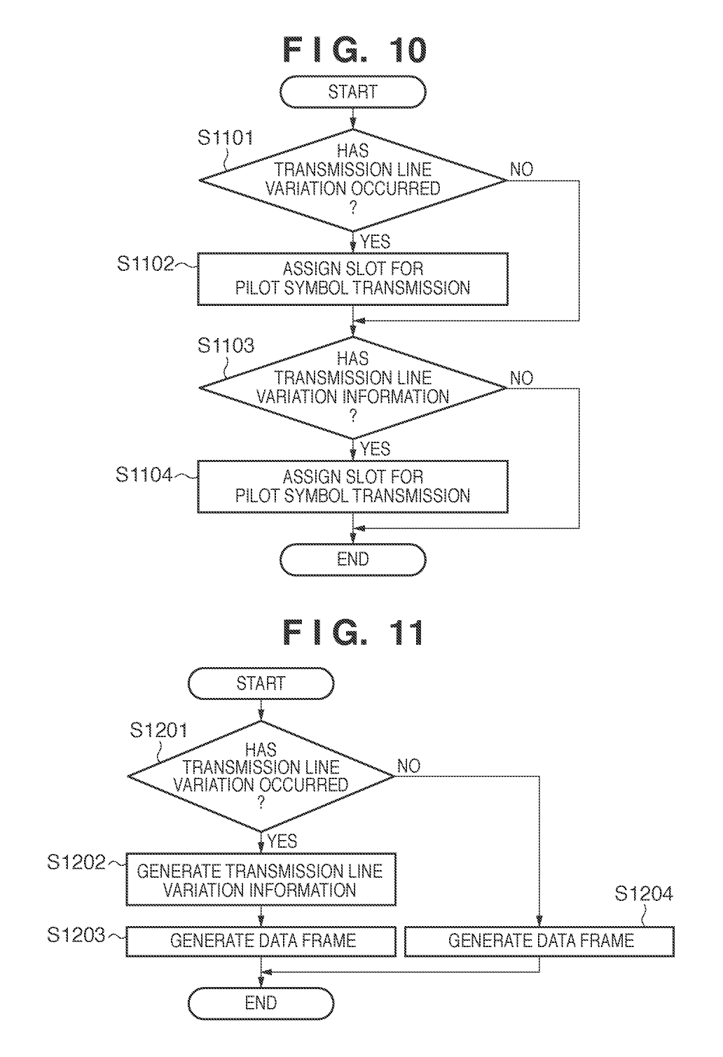

The operation of each station will now be described in detail with reference to FIGS. 10 and 11. FIG. 10 is a flowchart illustrating the operation of the transmission line variation information extracting unit and time slot assigning unit of the parent station in the second embodiment. In a case where an error has occurred in demodulated data, the time slot assigning unit 1004 determines at step S1101 that transmission line variation has occurred. Control then proceeds to step S1102. In a case where an error has not occurred in the demodulated data, control proceeds to step S1103.

At step S1102, the time slot assigning unit 1004 assigns the pilot symbol transmission slot of the next TDMA frame to the transmitting station of the data symbol in which an error has occurred. At step S1103, the transmission line variation information extracting unit 1003 identifies the transmission line variation information insertion flag 901 among the items of data received from the child stations 1702 to 1706 and determines whether transmission line variation information is being transmitted. If the result is that transmission line variation information is included, then the transmission line variation information extracting unit 1003 notifies the time slot assigning unit 1004 of the station that is requesting transmission of the pilot symbol. Control then proceeds to step S1104.

At step S1104, the time slot assigning unit 1004 assigns the pilot symbol transmission slot of the next TDMA frame to the station requesting transmission of the pilot symbol. It should be noted that in a case where the number of stations requesting transmission of a pilot symbol exceeds the number of pilot symbol transmission slots, the time slot assigning unit 1004 assigns the pilot symbol transmission slots in order starting from the station having the largest number of errors in the transmission line variation information.

FIG. 11 is a flowchart illustrating the operation of the transmission line variation information generating unit 803 and data frame generating unit 804 of a child station in the second embodiment. In a case where an error has been detected in demodulated data, the transmission line variation information generating unit 803 determines at step S1201 that transmission line variation has occurred. Control then proceeds to step S1202. If an error is not detected in the data, on the other hand, then control proceeds to step S1204.

At step S1202, the transmission line variation information generating unit 803 generates the transmission line variation information 902 comprising the transmitting station of the data symbol in which the error has occurred and the number of error bits. Control then proceeds to step S1203. At step S1203, the data frame generating unit 804 enables the transmission line variation information insertion flag 901 and generates a data frame in which the transmission line variation information 902 has been inserted. At step S1204, on the other hand, the data frame generating unit 804 disables the transmission line variation information insertion flag 901 and generates a data frame in which null data has been inserted as the transmission line variation information 902.

An example of time slot assignment in the second embodiment and operation of each station will be described with reference to FIG. 3B. Here it will be assumed that child station 1703 detects transmission line variation of parent station 1701 in TDMA frame No. 1.

The child station 1703 detects an error in the received data from parent station 1701 in the data symbol transmission slot 203 of TDMA frame No. 1 and generates transmission line variation information. In this case, the parent station 1701, which is the source of transmission of the transmission line variation information, and the number of error bits are described in the transmission line fluctuation information 902 that is generated. The child station 1703 generates a data symbol, which includes this transmission line fluctuation information 902, in data symbol transmission slot 205. It should be noted that it may be so arranged that the data symbol containing the variation information may be transmitted in the data symbol transmission slot 205 of TDMA frame No. 2 in accordance with the processing time necessary from detection of error in the received data to generation of the transmission line variation information.

On the other hand, the parent station 1701 extracts the transmission line fluctuation information 902 in the data symbol transmission slot 205 of TDMA frame No. 1. Owing to the received transmission line fluctuation information 902, the parent station 1701 determines that transmission line variation has occurred in this station and assigns the pilot symbol transmission slot of the next TDMA frame to itself.

As a result of such operation by each station, a station in which transmission line variation has occurred is assigned a pilot symbol transmission slot in the manner illustrated in the example of time slot assignment shown in FIG. 3B. In a case where there is no transmission line variation, therefore, the pilot symbol transmission slot is not assigned to any station and is vacant. By assigning a vacated pilot symbol transmission slot to each station as a data symbol transmission slot, it is possible to improve transmission efficiency. It may be so arranged that a vacated pilot symbol transmission slot is assigned to each station according to a prescribed pattern in a manner similar to that of the first embodiment.

Thus, in the second embodiment, the parent station 1701 and child stations 1702 to 1706 are provided with means for detecting transmission line variation, and a time slot is assigned such that a station in which transmission line variation has occurred will transmit a pilot symbol. As a result, there are fewer transmissions of redundant pilot symbols and more efficient TDMA communication is possible in comparison with the first embodiment.

### Third Embodiment

A third embodiment according to the present invention will now be described in detail with reference to the drawings. In a case where a station that exhibits severe transmission line variation exists, the accuracy with which transmission line characteristics are estimated will decline if there is a vacant interval between a pilot symbol and data symbol transmitted by this station. In the third embodiment, slot assignment is carried out such that with regard to a station to which both a pilot symbol transmission slot and a data symbol transmission slot have been assigned, the pilot symbol of this station is transmitted just prior to the data symbol.

In the first and second embodiments, the parent station 1701 places the pilot symbol transmission slot and the data symbol transmission slot at fixed positions. In the third embodiment, on the other hand, the parent station 1701 performs assignment of time slots by placing the pilot symbol transmission slot and the data symbol transmission slot at any of the positions in the TDMA frame. It should be noted that the structures of the parent station 1701 and child stations 1702 to 1706 are similar to those of the second embodiment and need not be described again.

FIG. 2C illustrates the structure of a TDMA frame 1401 in the third embodiment. The TDMA frame 1401 has been partitioned into nine time slots 1402 to 1410. The assignments of the time slots 1402 to 1410 are as follows: one preamble symbol transmission slot, six data symbol transmission slots and two pilot symbol transmission slots. Here the time slot 1402 is fixedly assigned as the preamble symbol transmission slot used by the parent station 1701 but the other times slots are assigned freely.

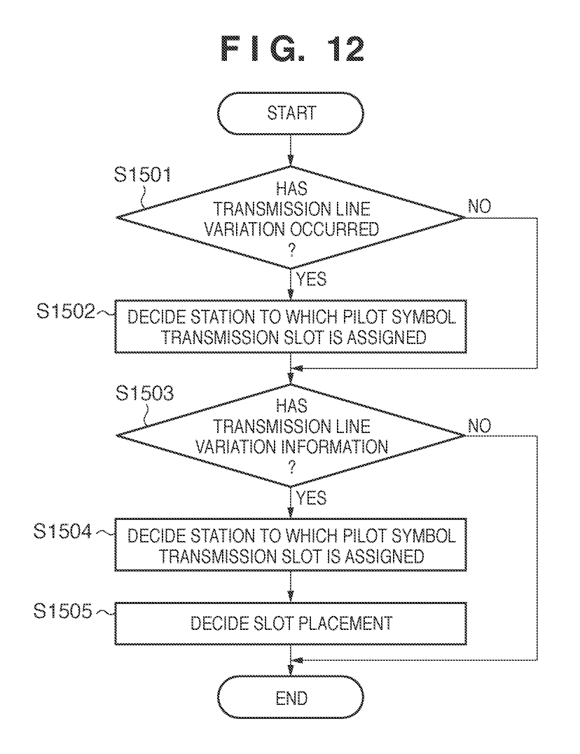

FIG. 12 is a flowchart illustrating the operation of a transmission line variation information extracting unit 1003 and time slot assigning unit 1104 of the parent station in the third embodiment. In a case where an error has occurred in demodulated data, the time slot assigning unit 1004 determines at step S1501 that transmission line variation has occurred. Control then proceeds to step S1502. In a case where an error has not occurred in the demodulated data, control proceeds to step S1503.

At step S1502, the time slot assigning unit 1004 temporarily stores the transmitting station of the data symbol in which a reception error has occurred as the station to which the pilot symbol transmission slot of the next TDMA frame is assigned. At step S1503, the transmission line fluctuation information extracting unit 1003 identifies the transmission line variation information insertion flag 901 among the items of data received from the child stations 1702 to 1706 and determines whether transmission line variation information 902 is being transmitted. If the result is that the transmission line variation information 902 is included, then the transmission line variation information extracting unit 1003 notifies the time slot assigning unit 1004 of the station that is requesting transmission of the pilot symbol. Control then proceeds to step S1504. If the transmission line variation information 902 is not included, on the other hand, then control proceeds to step S1505.

At step S1504, the time slot assigning unit 1004 temporarily stores the transmitting station requesting transmission of the pilot symbol as the station to which the pilot symbol transmission slot of the next TDMA frame is assigned. Control then proceeds to step S1505. At step S1505, the time slot assigning unit 1004 decides the slot placement such that with regard to the station to which the pilot symbol transmission slot is assigned, the pilot symbol of this station is transmitted just prior to the data symbol.

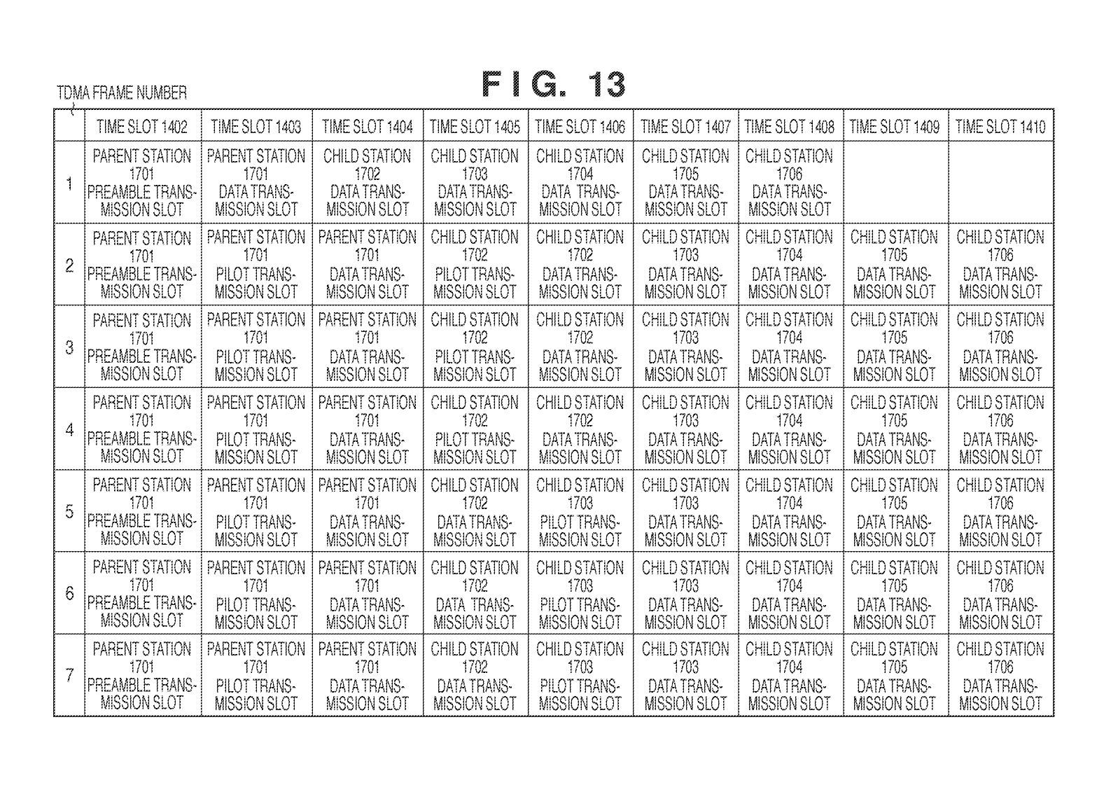

FIG. 13 is a diagram illustrating an example of assignment of time slots in the third embodiment. In the third embodiment, it is assumed that the transmission line between the parent station 1701 and child station 1702 exhibits variation from TDMA frames Nos. 1 to 3, and that the transmission line between the parent station 1701 and child station 1703 exhibits variation from TDMA frames Nos. 4 to 6. In this case, from TDMA frames Nos. 1 to 3, the child station 1702 detects transmission line variation from the signal received from parent station 1701 and requests the parent station 1701 to transmit the pilot symbol. On the other hand, the parent station 1701 detects transmission line variation from the signal received from the child station 1702. As a result, the parent station 1701 performs slot assignment in TDMA frame Nos. 2 to 4 such that the parent station and child station 1702 use the pilot symbol transmission slot.

Here the parent station 1701 places the pilot symbol transmission slot immediately in front of its own data symbol transmission slot. Furthermore, the parent station 1701 places the pilot symbol transmission slot immediately in front of the data symbol transmission slot of the child station 1702.

In the example shown in FIG. 13, in TDMA frame Nos. 2 to 4, the parent station 1701 places its own pilot symbol transmission slot in the time slot 1403 and places its own data symbol transmission slot in the time slot 1404. Further, the parent station 1701 places the pilot symbol transmission slot of the child station 1702 in the time slot 1405 and places the data symbol transmission slot of the child station 1702 in the time slot 1406.

Further, in TDMA frame Nos. 4 to 6, the child station 1703 detects transmission line variation from the signal received from the parent station 1701 and requests the parent station 1701 to transmit the pilot symbol. On the other hand, the parent station 1701 detects transmission line variation from the signal received from the child station 1703. As a result, the parent station 1701 performs slot assignment in TDMA frame Nos. 5 to 7 such that the parent station and child station 1703 use the pilot symbol transmission slot.

In this case, the parent station 1701 places its own pilot symbol transmission slot in the time slot 1403 and places its own data symbol transmission slot in the time slot 1404. Further, the parent station 1701 places the pilot symbol transmission slot of the child station 1703 in the time slot 1406 and places the data symbol transmission slot of the child station 1703 in the time slot 1407.

In the third embodiment, slot assignment is carried out such that with regard to a station to which both a pilot symbol transmission slot and a data symbol transmission slot have been assigned, the pilot symbol of this station is transmitted just prior to the data symbol. As a result, in an environment in which a station that exhibits severe transmission line variation exists, highly reliable TDMA communication in which it is possible to prevent a decline in accuracy with which the transmission line characteristics of this station are estimated can be implemented.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-240875, filed Oct. 19, 2009, which is hereby incorporated by reference herein in its entirety.

What is claimed is:

1. A method of communication in a communication apparatus for functioning as a parent station or child station that communicates using TDMA, comprising:
assigning the parent station or child station, which transmits a pilot symbol, to the pilot symbol transmission slot within a TDMA frame shared by the parent station and child station; and
transmitting the pilot symbol in the pilot symbol transmission slot by the assigned parent station or child station.

2. The method according to claim 1, wherein in the assigning step, the parent station and a plurality of child stations are assigned according to a predetermined pattern for every TDMA frame.

3. The method according to claim 1, further comprising a detecting step of detecting variation of a transmission line that transmits the TDMA frame;
wherein in the assigning step, the parent station or child station, which has detected variation of the transmission line in the detecting step, is assigned.

4. The method according to claim 1, wherein in the assigning step, the parent station or child station that transmits the pilot symbol is assigned to the pilot symbol transmission slot placed arbitrarily within the TDMA frame.

5. A communication apparatus for functioning as a parent station that communicates using TDMA, comprising:
an assigning unit configured to assign the parent station or child station, which transmits a pilot symbol, to the pilot symbol transmission slot within a TDMA frame shared by the parent station and child station; and
a transmitting unit configured to transmit the pilot symbol in the pilot symbol transmission slot by the assigned parent station.

6. A computer-readable recording medium on which a program for causing a computer to execute the method of communication set forth in claim 1 has been recorded.
